(19) United States
(12) Patent Application Publication
(10) Pub. No.: US 2011/0062143 A1
(43) Pub. Date: Mar. 17, 2011

(54) SLIDING CONTROL SYSTEM FOR A COOKING APPLIANCE

(75) Inventor: BRANDON L. SATANEK, STEVENSVILLE, MI (US)

(73) Assignee: WHIRLPOOL CORPORATION, BENTON HARBOR, MI (US)

(21) Appl. No.: 12/560,461

(22) Filed: Sep. 16, 2009

(51) Int. Cl. H05B 3/02

(52) U.S. Cl. 219/489

(57) ABSTRACT

A control display for an oven includes an interactive cook time delay screen having a slide bar for selecting a cook time delay. The slide bar has a length corresponding to the total time of a cooking cycle, such that moving the slide bar along a timeline simultaneously adjusts the start time and the stop time of the cooking cycle, while also allowing a user to delay the start of a cooking cycle. A temperature select screen includes a slide bar for selecting a cooking cycle temperature, and a cook time select screen allows selection of a cooking cycle time. A control lock feature allows a user to lock and unlock the control display by moving a slide bar from a lock position to an unlock position along a track. A controller controls the operation based on the delay time, cooking temperature and cook time selected.

### BACKGROUND OF THE INVENTION

1. Field of the Invention

The present invention pertains to the art of cooking appliance controls and, more particularly, to a touch-sensitive sliding control system which enables the simultaneous adjustment of starting and stopping times for a cooking cycle.

2. Description of the Related Art

In modern cooking appliances, cooking temperatures are usually adjusted utilizing a numeric keypad, which requires typing in a desired cooking temperature. Some products include arrow buttons which allow a user to toggle a temperature up and down by pressing a requisite button until the desired temperature is reached. Additionally, modern cooking appliances often provide a feature which locks the control panel buttons. When locked, any buttons pressed, either intentionally or accidentally, are not registered. Enabling and disabling this lock feature usually requires a precise set of actions to ensure the intention of the user. Recent products ask the user to hold down a button for several seconds, for example. However, many users often make mistakes during this process, such as releasing the button too soon. Once unlocked, heating generally begins when food is placed in the cooking cavity. Some products contain control features enabling heating to be delayed, so that cooking starts at a predetermined time. This type of control generally takes two forms. In a first control method, a user is allowed to set a start time which tells the cooking appliance when to turn on. In another control method, a user selects a stop time which tells the oven when to turn off. If a cook time is set, and it is shorter than the difference between the stop time and the current time, the result will be a delay in cooking. Unfortunately, current products only support one control method. Therefore, there exists a need to provide a control system which addresses both users who tend to think more about a starting time and users who tend to think more about an ending time of a cooking event. Additionally, there exists a need for a user-friendly temperature adjustment method which does not require repeated toggling of switches and a locking option that provides an easy mechanism for effectively locking and unlocking the controls of an oven.

### SUMMARY OF THE INVENTION

The present invention is directed to an oven including a control display adapted to display an interactive cook time delay screen having a slide bar for selecting a cook time delay. The slide bar has a length corresponding to the total time of a cooking cycle, such that moving the slide bar along a timeline simultaneously adjusts both the start time and the stop time of the cooking cycle, while also allowing a user to delay the start of a cooking cycle. The control display is also adapted to display a temperature select screen including a slide bar for selecting a cooking cycle temperature, and a cook time select screen for selection of a desired cooking cycle time. A control lock feature allows a user to lock and unlock the control display by moving a slide bar from a lock position to an unlock position along a track.

In use, a user first unlocks the control display screen if necessary, and activates a home screen. After choosing a desired cooking cycle, the user may choose to activate the temperature select screen to choose a cooking temperature, and/or the cook time select screen to choose a desired time period for the cooking cycle. The user may then choose to delay the start of the cooking cycle for a desired period of time, based on either the desired start time, or the desired stop or end time of the cooking cycle. A controller operates the oven based on the selected cooking cycle, cooking temperature cooking time and cook delay time selected.

Additional objects, features and advantages of the present invention will become more readily apparent from the following detailed description of preferred embodiments when taken in conjunction with the drawings wherein like reference numerals refer to corresponding parts in the several views.

### BRIEF DESCRIPTION OF THE DRAWINGS

FIG. 1 is a front view of an oven incorporating a sliding control system in accordance with the present invention;

FIG. 2 is a plan view of a Cook Time Delay screen of the present invention;

FIG. 3 is a plan view of a Temperature Select screen of the present invention;

FIG. 4 is a plan view of a Cook Time screen of the present invention;

FIG. 5A is a plan view of a Control Lock feature of the present invention;

FIG. 5B is a plan view of an alternative Control Lock feature of the present invention; and

FIG. 6 is an oven programming flow chart depicting a method of controlling an oven in accordance with the present invention.

### DETAILED DESCRIPTION OF PREFERRED EMBODIMENTS

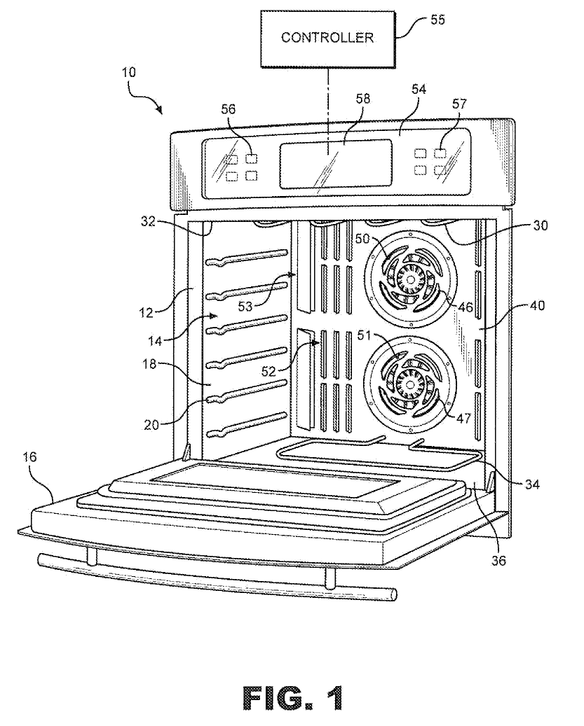

With initial reference to FIG. 1, a combination radiant heat and convection oven including the sliding control system of the present invention is generally indicated at 10. In the preferred embodiment shown, oven 10 is a wall-mounted or built-in oven, and includes a cabinet 12 which forms an oven cavity 14. A door 16 is pivotally mounted to cabinet 12 for selectively closing oven 10 and sealing oven cavity 14. Oven cavity 14 includes opposing side walls 18 having a plurality of spaced rails 20 for supporting repositionable racks (not shown) in a manner known in the art.

Oven 10 also includes a plurality of heating elements. More specifically, oven 10 includes an upper broil element 30 mounted adjacent an upper wall 32 of oven cavity 14 and a lower bake element 34 mounted adjacent a lower wall 36 of oven cavity 14. Upper broil element may be constituted by a 3600 watt resistive-type electric heating element, while lower bake element 34 may be constituted by a 2800 watt resistive-type electric heating element. A convection cover 40 is adapted to be mounted over first and second motor driven fans 46 and 47. Fans 46 and 47 may be constituted by multi-speed electric fans which can be continuously operated or pulsed as detailed below. In the embodiment shown, fans 46 and 47 are centrally mounted and vertically arranged within oven cavity 14, such that first and second fans 46 and 47 are aligned with and positioned at respective first and second circular apertures 50 and 51 formed in convection cover 40. Convection cover 40 also includes first and second plurality of spaced angled louvered openings 52 and 53 on either side of first and second fans 46 and 47, with louvered openings 52 and 53 being adapted to distribute heated air evenly throughout oven cavity 14. At this point, it should be realized that the details of oven 10 above are for illustrative purposes only. In general, the present invention is directed to a user interface 54 arranged in communication with a controller 55, and is not meant to be limited for use with any particular oven.

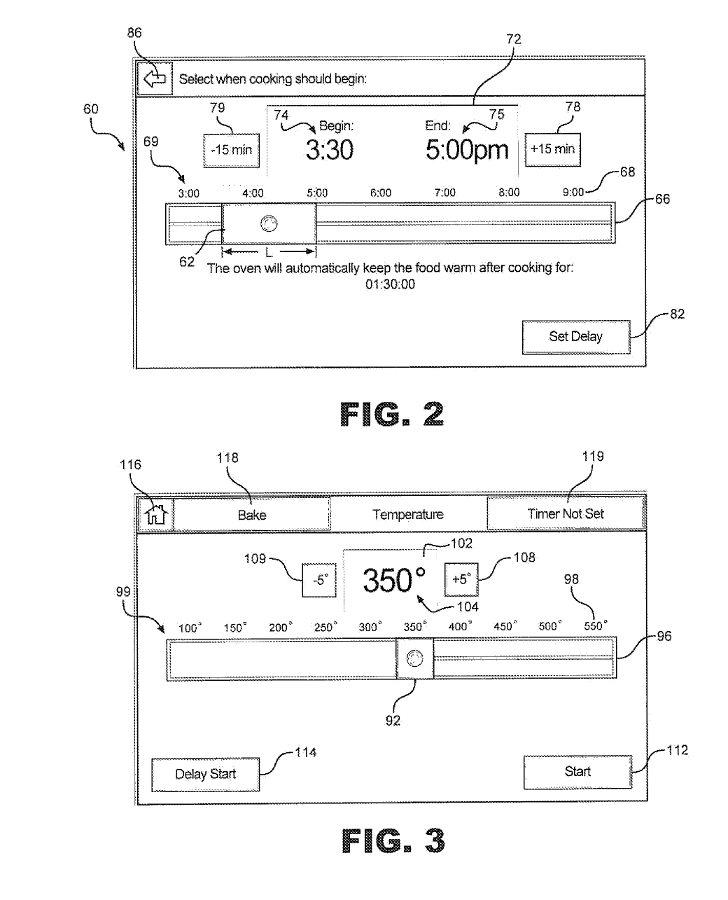

In accordance with the present invention, interface 54 includes a plurality of mode or operation selectors 56 and 57, as well as a touch-sensitive control display 58. In the embodiment shown, touch-sensitive control display 58 is constituted by a 7-inch LCD screen. Control display 58 is adapted to display a plurality of user interface screens including an interactive Cook Time Delay screen 60 depicted in FIG. 2. Cook Time Delay screen 60 includes a virtual slide bar 62 adapted to be positioned by a user at various points along the length of a virtual track 66. Virtual track 66 is in the form of a timeline, including time indicia 68 located at intervals along virtual track 66. Time indicia 68 are preferably in the form of a digital time display 69 which spans a 7-hour time period. For example, as depicted in FIG. 2, digital time display 69 includes time indicia 68 for 3:00 pm through 9:00 pm. Cook Time Delay screen 60 further includes a text display 72 adapted to digitally display a cooking cycle start time indicated at 74 and a cooking cycle stop or end time indicated at 75. Cook Time Delay screen 60 further includes a first virtual toggle button 78 adapted to adjust the start time of the cooking cycle by a positive set time increment upon selection of the first toggle button 78, and a second virtual toggle button 79 adapted to adjust the start time of the cooking cycle by a negative set time increment upon selection of the second virtual toggle button 79. In the embodiment shown in FIG. 2, for example, toggle buttons 78 and 79 are set for plus and minus 15 minute increments respectfully.

When a user desires to set a start or stop time for a cooking cycle, the user can adjust the time in one of three ways. First, a user may touch control display 58 at slide bar 62 and slide his/her finger across track 66 until slide bar 62 is positioned at a desired start time 74 or stop time 75. Slide bar 62 has a length L corresponding to a total time of a cooking cycle (which is also set by a user as detailed below), such that sliding slide bar 62 along track 66 simultaneously adjusts start time 74 and stop time 75 of the cooking cycle, while also allowing a user to delay cooking. For example, slide bar 62 depicted in FIG. 2 has a length L corresponding to a 1.5 hour total cooking cycle. As slide bar 62 slides along track 66, the corresponding start and stop times 74 and 75 are displayed on text display 72 and adjust automatically so that a user can quickly and easily identify the position of slide bar 62 on track 66. Another way in which a user may select a delay time is by touching an empty portion of track 66 at a desired location based on time indicia 68. Slide bar 62 will automatically move to the location selected by the user. Slide bar 62 may also be configured to shift to the nearest start point location on track 66, to the nearest end point location on track 66, or to the nearest mid-point of slide bar 62. Another way in which a user may set the delay time is by touching virtual toggle buttons 78 and 79, which will automatically move slide bar 62 along track 66 while displaying the chosen time period on text display 72. When a desired start and/or stop time 74, 75 is selected, a user touches a Set Delay button 82, at which point the selection is set, and controller 55 controls the operation of one or more of elements of oven 10 based on the delay time selected.

A menu exit button 86 may be selected to return the user to a previous menu screen or home screen (not shown). In accordance with the present invention, control display 58 is also adapted to display a Temperature Select screen 90 depicted in FIG. 3, which can be accessed by selecting an option from the main menu or home screen (not shown). Temperature Select screen 90 includes a virtual slide bar 92 adapted to be positioned by a user at various points along the length of a virtual track 96. Virtual track 96 includes temperature indicia 98 located at intervals along track 96. Temperature indicia 98 are preferably in the form of a digital temperature display 99 which generally spans the temperature range of oven 10. For example, as depicted in FIG. 3, digital temperature display 99 includes temperature indicia 98 between 100° F. and 550° F. Temperature Select screen 90 further includes a text display 102 adapted to digitally display a selected cooking temperature indicated at 104 of a cooking cycle. Temperature Select screen 90 further includes a first virtual toggle button 108 adapted to adjust the temperature of a cooking cycle by a positive set temperature increment upon selection of the first toggle button 108 and a second virtual toggle button 109 adapted to adjust the temperature of the cooking cycle by a negative set temperature increment upon selection of the second virtual toggle button 109. In the embodiment shown in FIG. 3, for example, toggle buttons 108 and 109 are set at plus and minus 5° F. increments respectfully.

When a user desires to set a temperature for a cooking cycle, the user can adjust the temperature in one of three ways. First, a user may touch control display 58 at slide bar 92 and slide his/her finger across track 96 until slide bar 92 is positioned at a desired temperature. As slide bar 92 slides along track 96, the corresponding temperature 104 is displayed on text display 102 so that a user can quickly and easily identify the position of slide bar 92 on track 96. Another way in which a user may select a temperature is by touching an empty portion of track 96 at a desired location based on temperature indicia 98. Slide bar 92 will automatically move to the location selected by the user. Optionally, slide bar 92 may be configured to shift or snap to the nearest temperature indicia 98 on track 96. Another way in which a user may set a desired cooking temperature is by touching virtual toggle buttons 108 and 109, which will automatically move slide bar 92 along track 96 by increments of 5 degrees while displaying the chosen temperature on text display 102. When a desired temperature is selected, a user may touch a Start button 112, at which point a cooking cycle starts. During the cooking cycle, controller 55 controls the operation of one or more of heating elements 30, 34 and fans 46, 47 based on the temperature selected. If a user wishes to delay the start of the cooking cycle, the user may select a Delay Start button 114, which will bring up Cook Time Delay screen 60 of FIG. 2. Temperature Select screen 90 also includes a menu exit button 116, which may then be selected to return a user to the main menu screen (not shown). Additionally, an indicator 118 displays a current cook cycle setting.

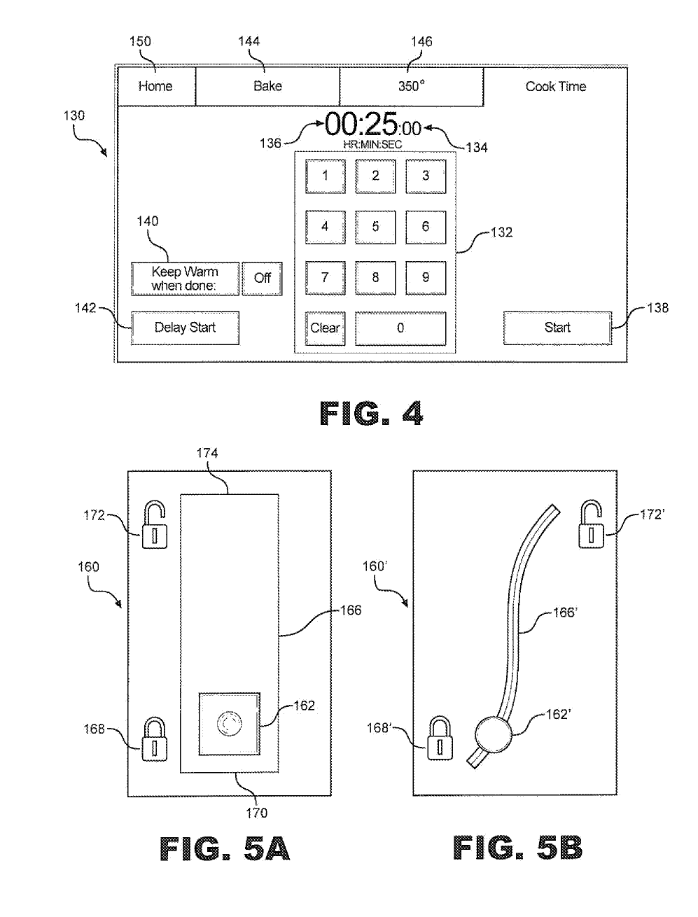

If a user wishes to set a cook time for the cooking cycle selected, the user may select indicator 119 to activate a Cook Time screen 130 shown in FIG. 4. Cook Time screen 130 preferably includes a plurality of numeric buttons 132 and a text display 134 for displaying the set cook time as indicated at 136. Additionally, Cook Time screen 130 includes a start button 138, as well as a food warmer option indicated at 140. In accordance with the present invention, a Delay Start button 142 is also provided to enable activation of Cook Time Delay screen 60. Additionally, an indicator 144 displays a current cook cycle setting and an indicator 146 displays a current temperature setting. A home button 150 is also provided for returning a user to a main menu screen (not shown).

Another aspect of the present invention is a Control Lock feature 160 depicted in FIG. 5A. Control Lock feature 160 preferably appears on an idle screen or clock screen (not shown) of user interface 54 when oven 10 is in a standby mode. More specifically, Control Lock feature 160 enables a user to selectively lock the controls on control display 58 to prevent any unintentional or unwanted programming of oven 10. Control Lock feature 160 includes a virtual slide bar 162 adapted to be positioned by a user along the length of a virtual track 166. Control Lock feature 160 further includes a lock indicia 168 at a first end 170 and an unlock indicia 172 at a second end 174 of track 166. In use, a user touches slide bar 162 and slides the bar along track 166 from one end (either 140 or 144) to the other end (the other of 140 or 144). Track 166 may be in the form of a straight track 166 as depicted in FIG. 5A, or may be in another form, such as the generally serpentine track 166′ as depicted in FIG. 5B. Like slide bar 162, slide bar 162′ can slide from a first end 170′ to a second end 174′ of track 166′ to selectively lock or unlock user interface 54 as indicated by indicia 168′ and 172′. It should be recognized that more complex shapes for track 166, 166′ are generally more difficult for a child to trace accurately, thus restricting the use of oven 10. Additionally, more complex shapes help prevent accidental deactivation or unlocking of the control system while wiping or cleaning user interface 54. In accordance with a preferred method of the present invention, unlocking the control display requires following the shape of track 166, 166′ from a first end 170, 170′ to a second end 174, 174′ in order to move slide bar 162, 162′ along track 166, 166′ from a locked position to an unlocked position, wherein failure to follow the entire length of track 166, 166′ results in a failure to unlock control display 58.

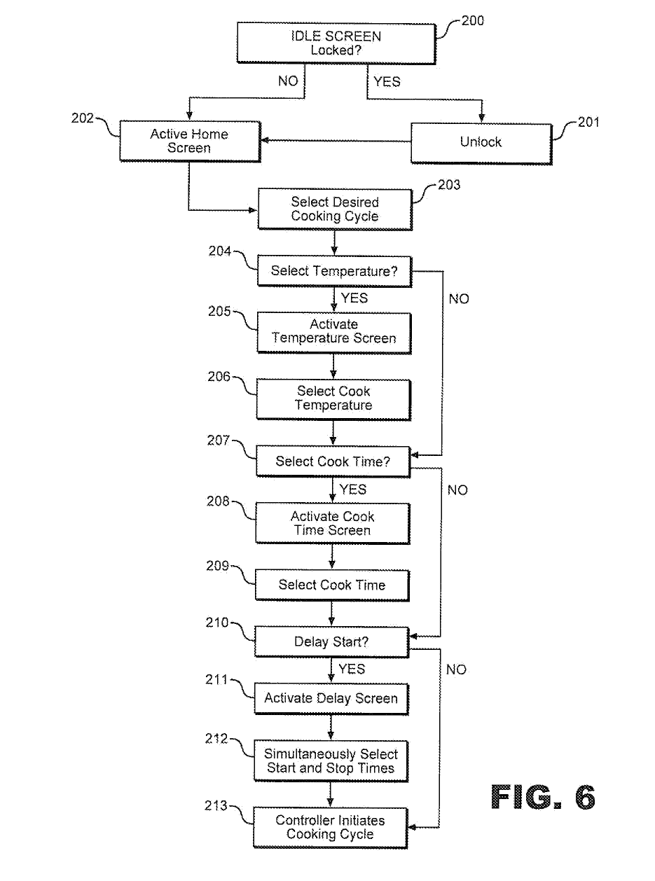

A typical programming cycle for oven 10 will now be discussed with reference to the flow chart in FIG. 6. Initially, when oven 10 is dormant, an idle screen (not shown) will be displayed which includes Control Lock feature 160 or 160′ as depicted at step 200. If the user has previously locked user interface 54, the user will slide bar 162, 162′ along track 166, 166′ from a locked position at end 170, 170′ to an unlock position at end 174, 174′ as indicated at 201. Once the Control Lock feature 160, 160′ is unlocked, a menu or home screen (not shown) will be presented as indicated at step 202. A desired cooking cycle may then be selected by the user at step 203. The cooking cycle may be a bake cycle, broil cycle, convection cycle, preheat cycle, or pre-programmed cooking cycle, for example. If a temperature setting step is required and indicated at step 204, a user activates Temperature Select screen 90 at step 205. In a preferred method of the present invention, the desired cooking temperature is set at step 206 utilizing Temperature Select screen 90. Alternatively, a user may select a desired temperature using conventional controls. If a cook time selection step is required and indicated at step 207, a user activates Cook Time screen 130 at step 208 and selects a desired cook time at step 209. Once any required temperature and cook times are set, a user may then choose to delay the start of the cooking cycle at step 210 by activating a Cook Time Delay screen 60 of the present invention at step 211. This step may be practiced by selecting one of delay start buttons 114 or 142 on respective Temperature Select and Cook Time screens 90 and 130, or by selecting a delay start button displayed on another menu not shown. The user then simultaneously selects the cooking cycle start time 74 and the cooking cycle stop time 75 utilizing slide bar 62 at step 212, as described in detail above. Controller 55 will then activate oven 10 at step 213, including cooking elements (i.e., one or more of broil element 30, lower bake element 34, and fans 46 and 47) in accordance with the cooking cycle selected at step 203, taking into account any cooking temperature selected at step 206, cooking time selected at step 209 and time delay selected at step 212.

Advantageously, the control system and method of the present invention allow a user to focus on either a desired start time or a desired stop time for a cooking cycle. Although described with reference to a preferred embodiment of the invention, it should be readily understood that various changes and/or modifications can be made to the invention without departing from the spirit thereof. For instance, although user interface 54 is depicted as a LCD touch screen, it should be understood that actual slider buttons could be utilized without departing from the spirit of the invention. In general, the invention is only intended to be limited by the scope of the following claims.

I/We claim:

1. A cooking appliance comprising:
a cabinet defining an oven cavity;
a door attached to the cabinet for selectively exposing and sealing the oven cavity;
a cooking element mounted to the cabinet for heating the oven cavity;
a touch sensitive control display adapted to display an interactive cook time delay screen including a first virtual slide bar adapted to be positioned by a user along a first virtual track, wherein the first virtual track establishes a timeline including time indicia at spaced intervals along the first virtual track, the first virtual slide bar having a length corresponding to a total time of a cooking cycle having a start time and a stop time, such that sliding the first virtual slide bar along the first virtual track simultaneously adjusts the start time and the stop time of the cooking cycle and allows a user to delay cooking until a selected start time; and
a controller in communication with the user interface for controlling operation of the cooking element based on the positioning of the first virtual slide bar along the first virtual track.

2. The cooking appliance of claim 1, wherein the touch sensitive control display is further adapted to display a temperature select screen including a second virtual slide bar adapted to be positioned by a user along a second virtual track, said second virtual track including temperature indicia at spaced intervals along the second virtual track, wherein sliding the second virtual slide bar along the second virtual track adjusts a cooking temperature of the cooking cycle, and wherein the controller in communication with the user interface controls operation of the cooking element based on the positioning of the second virtual slide bar along the second virtual track.

3. The cooking appliance of claim 2, wherein the temperature select screen further includes a delay button which is adapted to activate the cook time delay screen.

4. The cooking appliance of claim 2, wherein the touch sensitive control display is further adapted to display a control lock feature including a third virtual slide bar adapted to be positioned by a user along a third virtual track, said third virtual track including a lock indicia at a first end and an unlock indicia at a second end, wherein a user may selectively lock or unlock controls for the cooking appliance by sliding the third virtual slide bar between the first end and the second end.

5. The cooking appliance of claim 1, wherein the touch sensitive control display is further adapted to display a control lock feature including a second virtual slide bar adapted to be positioned by a user along a second virtual track, said second virtual track including a lock indicia at a first end and an unlock indicia at a second end, wherein a user may selectively lock or unlock controls for the cooking appliance by sliding the second virtual slide bar between the first end and the second end.

6. The cooking appliance of claim 5, wherein the second virtual slide bar has a serpentine shape which requires a user to touch the control display and continuously follow a serpentine shape of the second virtual slide bar from the first end to the second end in order in order to unlock the control lock feature.

7. The cooking appliance of claim 1, wherein the touch sensitive control display is further adapted to display a cook time screen including a plurality of numeric buttons for selecting a total cook time of the cooking cycle.

8. The cooking appliance of claim 7, wherein the cook time screen further includes a delay button for activating the cook time delay screen.

9. The cooking appliance of claim 1, wherein the cook time delay screen further includes a first virtual toggle button adapted to adjust the start time of the cooking cycle by a positive set time increment upon selection of the first toggle button and a second virtual toggle button adapted to adjust the start time of the cooking cycle by a negative set time increment upon selection of the second virtual toggle button.

10. The cooking appliance of claim 1, wherein the cook time delay screen further includes a text display indicating the start time and the stop time of the cooking cycle based on the position of the first virtual slider bar.

11. A touch sensitive control display for presenting an interactive cook time delay screen for an oven comprising:
a first virtual slide bar adapted to be positioned by a user along a first virtual track, wherein the first virtual track establishes a timeline including time indicia at spaced intervals along the first virtual track, the first virtual slide bar having a length corresponding to a total time of a cooking cycle having a start time and a stop time, such that sliding the first virtual slide bar along the first virtual track simultaneously adjusts the start time and the stop time of the cooking cycle and allows a user to delay cooking until a selected start time.

12. The touch sensitive control display of claim 11, further comprising:
a first virtual toggle button adapted to adjust the start time of the cooking cycle by a positive set time increment upon selection of the first toggle button; and
a second virtual toggle button adapted to adjust the start time of the cooking cycle by a negative set time increment upon selection of the second virtual toggle button.

13. The touch sensitive control display of claim 11, further comprising:
a text display indicating the start time and the stop time of the cooking cycle based on the position of the first virtual slide bar.

14. A method for delaying the start time of a cooking cycle in an oven including a touch-sensitive control display adapted to display a plurality of user-interface screens upon activation by a user comprising:
selecting a cooking cycle utilizing the touch-sensitive control display;
activating a cook time delay screen including a virtual slide bar positionable along a virtual track presenting a timeline having time indicia at spaced intervals along the virtual track, wherein the virtual slide bar includes a length corresponding to a total time for the cooking cycle; and
moving the virtual slide bar to a desired location on the virtual track to simultaneously select both a start time and a stop time for the cooking cycle.

15. The method of claim 14, further comprising: simultaneously displaying the start time and the stop time on a text display of the cook time delay screen.

16. The method of claim 14, further comprising:
activating a temperature select screen including a second virtual slide bar and a second virtual track for the second virtual slide bar, the second virtual track including temperature indicia at spaced intervals along the second virtual track; and
moving the second virtual slide bar to a desired location on the second virtual track to select a desired temperature for the cooking cycle, wherein touching a delay button on the temperature select screen activates the cook time delay screen.

17. The method of claim 16, further comprising: initially unlocking the touch-sensitive control display, wherein unlocking the touch-sensitive control display includes moving a third virtual slide bar continuously along a third virtual track from a first end to a second end to slide the third virtual slide bar along the third virtual track from a locked position at the first end to an unlocked position at the second end, wherein failure to follow an entire length of the third virtual track results in a failure to unlock the touch-sensitive control display.

18. The method of claim 14, further comprising: initially unlocking the touch-sensitive control display, wherein unlocking the touch-sensitive control display includes moving a second virtual slide bar continuously along a second virtual track from a first end to a second end to slide the second virtual slide bar along the second virtual track from a locked position at the first end to an unlocked position at the second end.

19. The method of claim 18, wherein failure to follow an entire length of the second virtual track results in a failure to unlock the touch-sensitive control display.

20. The method of claim 14, further comprising:
activating a cook time screen including a plurality of numeric buttons; and
setting the total time for the cooking cycle utilizing the numeric buttons, wherein touching a delay button on the cook time screen activates the cook time delay screen.
